(19) United States
(12) Patent Application Publication
(10) Pub. No.: US 2017/0279907 A1
(43) Pub. Date: Sep. 28, 2017

(54) Behavior Analysis Apparatus for Analysis of User's Behavior, Behavior Analysis Method, and Storage Medium

(71) Applicant: CASIO COMPUTER CO., LTD., Shibuya-ku (JP)

(72) Inventor: Kazunori KITA, Hamura-shi (JP)

(21) Appl. No.: 15/450,387

(22) Filed: Mar. 6, 2017

(30) Foreign Application Priority Data
Mar. 24, 2016 (JP) 2016-060473

(51) Int. Cl. H04L 29/08; G01P 13/00

(52) U.S. Cl. CPC H04L 67/22; G01P 13/00; G08B 21/0423

(57) ABSTRACT

A behavior analysis apparatus 1 executes: a particular behavior acquisition processing of identifying a particular behavior of a user; and a behavior analysis processing of analyzing a related behavior of the user different from the particular behavior, the related behavior being performed in a period corresponding to the particular behavior.

### CROSS-REFERENCE TO RELATED APPLICATIONS

This application is based upon and claims the benefit of priority under 35 USC 119 of Japanese Patent Application No. 2016-060473 filed on Mar. 24, 2016 the entire disclosure of which, including the description, claims, drawings, and abstract, is incorporated herein by reference in its entirety.

### BACKGROUND OF THE INVENTION

Field of the Invention

The present invention relates to a behavior analysis apparatus for analysis of a user's behavior, a behavior analysis method, and a storage medium.

Related Art

According to a technique conventionally known, a user's behavior is analyzed based on measurement results acquired by various sensors.

For example, Japanese Patent Application Publication No. 2015-188605 discloses a technique of calculating the speed, etc. of a user wearing a sensor by grasping the motion of the user such as walking and analyzing the motion of the user.

### SUMMARY OF THE INVENTION

A behavior analysis apparatus according to one aspect of the present invention comprises a processor(s), wherein the processor(s) executes:

a particular behavior acquisition processing of identifying a particular behavior of a user; and

a behavior analysis processing of analyzing a related behavior of the user in a period corresponding to the particular behavior.

A behavior analysis method according to one aspect of the present invention is executed by a behavior analysis apparatus.

The method comprises:

a particular behavior acquisition processing of identifying a particular behavior of a user; and

a behavior analysis processing of analyzing a related behavior of the user in a period corresponding to the particular behavior.

A non-transitory storage medium according to one aspect of the present invention encoded with a computer-readable program that controls a processor(s) of a behavior analysis apparatus to execute:

a particular behavior acquisition processing of identifying a particular behavior of a user; and

a behavior analysis processing of analyzing a related behavior of the user in a period corresponding to the particular behavior.

### BRIEF DESCRIPTION OF THE DRAWINGS

FIG. 1 is a block diagram showing the hardware configuration of a behavior analysis apparatus according to an embodiment of the present invention.

FIG. 2 is a functional block diagram showing a functional configuration for executing behavior analysis processing belonging to the functional configuration of the behavior analysis apparatus shown in FIG. 1.

FIG. 3 is a schematic view showing how a particular behavior is detected from behavior history data about a user.

FIG. 4 is a schematic view showing how a related behavior associated with a particular behavior is identified by detecting the particular behavior.

FIG. 5 is a flowchart for explaining a flow of the behavior analysis processing executed by the behavior analysis apparatus of FIG. 1 having the functional configuration of FIG. 2.

FIG. 6 is a flowchart for explaining a flow of standing-up, sitting-down, and move determination processing executed in step S18 of the behavior analysis processing.

FIG. 7 is a flowchart for explaining a flow of moving means determination processing.

### DETAILED DESCRIPTION OF THE INVENTION

Embodiments of the present invention will be described below by referring to the drawings.

### First Embodiment

### [Hardware Configuration]

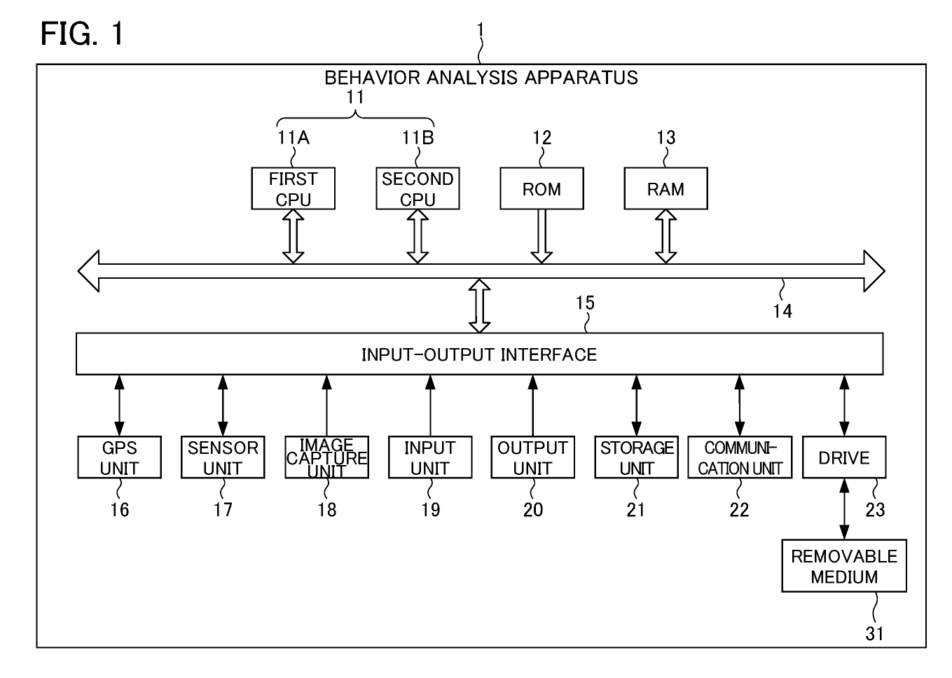

FIG. 1 is a block diagram showing the hardware configuration of a behavior analysis apparatus 1 according to an embodiment of the present invention.

The behavior analysis apparatus 1 is configured as a smartphone or a wearable appliance such as a wrist terminal, for example. The behavior analysis apparatus 1 is used while being carried by or attached to a user.

The behavior analysis apparatus 1 includes a first central processing unit (CPU) 11A, a second CPU 11B, a read only memory (ROM) 12, a random access memory (RAM) 13, a bus 14, an input-output interface 15, a global positioning system (GPS) unit 16, a sensor unit 17, an image capture unit 18, an input unit 19, an output unit 20, a storage unit 21, a communication unit 22, and a drive 23.

The first CPU 11A and the second CPU 11B execute various types of processing according to a program stored in the ROM 12 or a program loaded from the storage unit 21 into the RAM 13. For example, the first CPU 11A and the second CPU 11B execute behavior analysis processing described later according to a program prepared for the behavior analysis processing.

The first CPU 11A is configured to be operable with lower power consumption (at a lower operation clock frequency, for example) than the second CPU 11B. The function of the second CPU 11B may be fulfilled by a field-programmable gate array (FPGA) or an application specific integrated circuit (ASIC). As shown in FIG. 1, the first CPU 11A and the second CPU 11B are collectively called a CPU 11 in this embodiment.

The RAM 13 contains data, and the like stored as appropriate and necessary for execution of various types of processing by the first CPU 11A and the second CPU 11B.

The first CPU 11A, the second CPU 11B, the ROM 12, and the RAM 13 are connected to each other via the bus 14. The input-output interface 15 is also connected on the bus 14. The input-output interface 15 is further connected to the GPS unit 16, the sensor unit 17, the image capture unit 18, the input unit 19, the output unit 20, the storage unit 21, the communication unit 22, and the drive 23.

The GPS unit 16 includes an antenna. The GPS unit 16 receives GPS signals transmitted from a plurality of GPS satellites to acquire position information about the behavior analysis apparatus 1.

The sensor unit 17 includes various sensors such as a triaxial acceleration sensor, a gyroscopic sensor, a magnetic sensor, an air pressure sensor, and a biometric sensor, for example.

The image capture unit 18 includes an optical lens unit and an image sensor, which are not shown.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 18.

Such an output signal from the image capture unit 18 is supplied, as appropriate, to the first CPU 11A or the second CPU 11B, and the like.

The input unit 19 is configured by various buttons and the like, and inputs a variety of information in accordance with instruction operations by the user.

The output unit 20 is configured by the display unit, a speaker, and the like, and outputs images and sound.

The storage unit 21 is configured by DRAM (Dynamic Random Access Memory) or the like, and stores data of various images.

The communication unit 22 controls communication with a different apparatus (not shown in the drawings) via a network including the Internet. The communication unit 22 includes a wireless tag such as a radio frequency identifier (RFID) tag or a near field communication (NFC) tag, for example.

A removable medium 31 composed of a magnetic disk, an optical disk, a magneto-optical disk, semiconductor memory or the like is installed in the drive 23, as appropriate.

Programs that are read via the drive 23 from the removable medium 31 are installed in the storage unit 21, as necessary.

Similarly to the storage unit 19, the removable medium 31 can also store a variety of data such as the image data stored in the storage unit 21.

### [Functional Configuration]

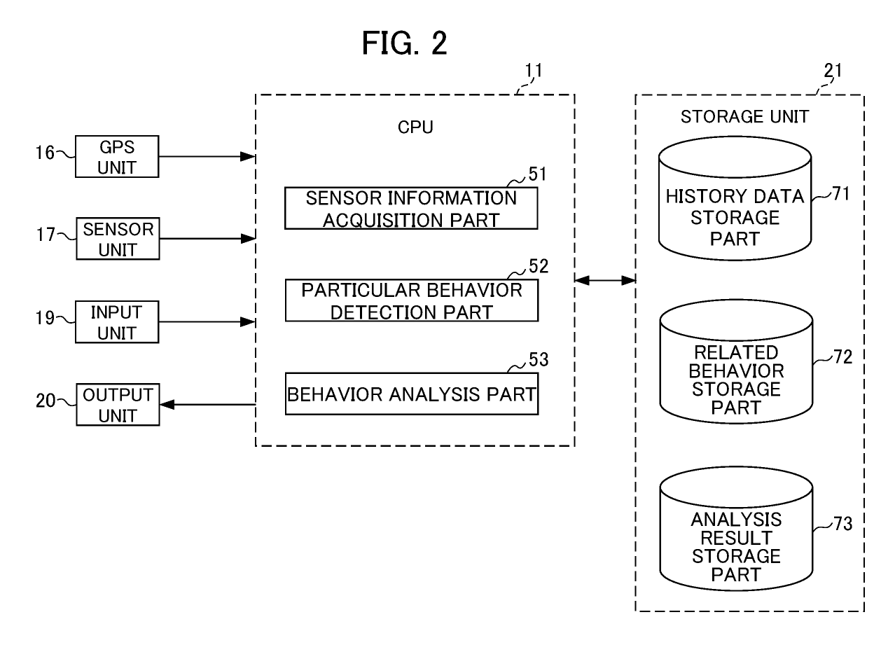

FIG. 2 is a functional block diagram showing a functional configuration for executing the behavior analysis processing belonging to the functional configuration of the behavior analysis apparatus 1 shown in FIG. 1.

The behavior analysis processing is a processing sequence of analyzing a behavior of a user by detecting a particular behavior of the user as a cue for behavior analysis, and determining a behavior performed in a period adjacent to the particular behavior (a period temporally before or after the particular behavior) in association with the particular behavior.

As shown in FIG. 2, for execution of the behavior analysis processing, a sensor information acquisition part 51 and a particular behavior detection part 52 become functional in the first CPU 11A. Further, a behavior analysis part 53 becomes functional in the second CPU 11B.

A history data storage part 71, a related behavior storage part 72, and an analysis result storage part 73 are set in some region of the storage unit 21.

The history data storage part 71 contains behavior history data about a user. For example, the history data storage part 71 contains history data about various operations of the behavior analysis apparatus 1 such as positioning data acquired by the GPS unit 16, output data acquired by the various sensors of the sensor unit 17, a communication history such as a history of transmission of mails, and a history of an application used by the user, for example.

The related behavior storage part 72 contains a particular behavior of the user (hereinafter will be called a “particular behavior”, as appropriate) and a behavior related to this particular behavior (hereinafter will be called a “related behavior”, as appropriate) that are stored in association with each other. A behavior to be defined as the particular behavior is one very likely to be performed before or after a given related behavior, or before and after the given related behavior.

More specifically, a particular behavior includes a first particular behavior corresponding to start of a given related behavior, and a second particular behavior corresponding to end of the given related behavior. A combination of the first particular behavior and the second particular behavior, which are behaviors corresponding to start and end of the given related behavior respectively, can be defined as the particular behavior.

Specifically, a first particular behavior suggests start of an associated related behavior, whereas a second particular behavior suggests end of the associated related behavior.

If a first particular behavior is to “go out through a front door at a particular time on weekdays”, for example, “going to work” is associated as a related behavior with this first particular behavior.

If a second particular behavior is to “capture a given number of images or more at a position separated from home by a constant distance or more”, for example, “going for a trip” is associated as a related behavior with this second particular behavior.

If a first particular behavior is to “sit down” and a second particular behavior is to “stand up” to be performed during a desk job in a workplace, and if these first particular behavior and second particular behavior are combined as a particular behavior, for example, “doing a job (desk job)” is associated as a related behavior with this combination.

Each of a particular behavior and a related behavior can be defined as a single behavior or as a combination of a plurality of behaviors. For example, a combination of behaviors including “standing up after wake-up” and “sitting down thereafter” can be defined as a first particular behavior. In this case, “having a meal” can be defined as a related behavior. If a related behavior is to “go to work”, for example, a combination of three types of behaviors including “walking”, “move by bus”, and “move by train” can be defined as this related behavior.

As described above, if a behavior is analyzed based only on an output from a sensor and if a situation is such that an acquired analysis result is about a behavior currently performed itself (“sitting down” or “be sitting”, for example), the behavior analysis apparatus 1 of this embodiment determines whether or not the analyzed behavior is a related behavior (“having a meal”, for example) defined in association with a behavior performed before or after the related behavior.

The analysis result storage part 73 contains a user's behavior resulting from the behavior analysis processing. For example, the analysis result storage part 73 contains the following behaviors stored in chronological order as behaviors of a user performed in a day: wake-up, having a meal (breakfast), going to work, doing a job, going home, jogging, having a meal (dinner), and going to sleep.

The sensor information acquisition part 51 acquires positioning data from the GPS unit 16 and output data from the various sensors of the sensor unit 17, and stores the acquired data as behavior history data about a user into the history data storage part 71.

The particular behavior detection part 52 refers to the related behavior storage part 72 to detect a particular behavior as a cue for behavior analysis from behavior history data about a user stored in the history data storage part 71.

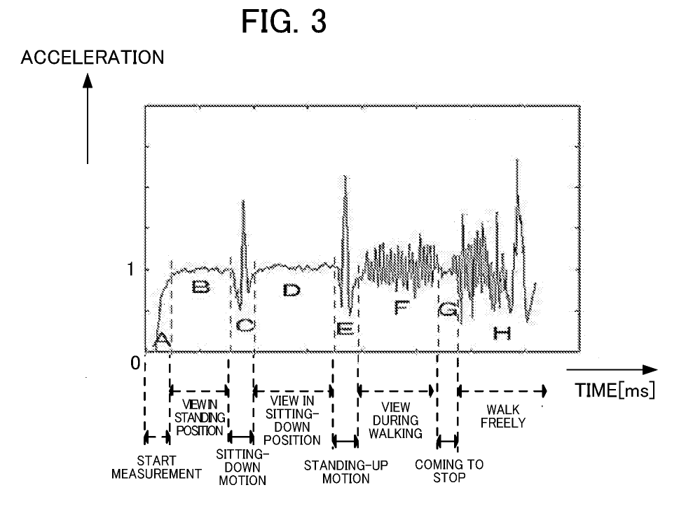

FIG. 3 is a schematic view showing how a particular behavior is detected from behavior history data about a user. FIG. 3 shows how a standing-up motion and a sitting-down motion are detected as particular behaviors of a user from output data acquired from the acceleration sensor.

As shown in FIG. 3, if the user makes a sitting-down motion (period C) or a standing-up motion (period E) while viewing the behavior analysis apparatus 1 in various situations, these behaviors can be detected as particular behaviors.

If the particular behavior detection part 52 detects a particular behavior from behavior history data about a user stored in the history data storage part 71, the behavior analysis part 53 refers to the related behavior storage part 72 to determine whether or not the behavior history data about the user contains a related behavior associated with the detected particular behavior. If the behavior history data about the user does not contain a related behavior associated with the detected particular behavior, the behavior analysis part 53 determines a behavior having a likelihood of having been performed by the user based on a behavior element (a behavior of a minimum unit in the history) and a behavior type (a type of a behavior performed in the life of the user) contained in the behavior history data about the user. At this time, to place importance on producing a correct determination result, a range of determining the behavior may be set in such a manner that the behavior to be determined can specifically be identified based on the behavior history data about the user. For example, a determination result showing that “the user moved from a point X to a point Y at speed Z [km] per hour” can specifically be produced based on acquired data. This can reduce the probability of making a false determination.

If the behavior history data about the user contains a related behavior associated with the detected particular behavior, the behavior analysis part 53 determines this related behavior as a behavior of the user.

More specifically, the behavior analysis part 53 acquires a related behavior stored in the related behavior storage part 72 in association with the particular behavior detected by the particular behavior detection part 52. Then, the behavior analysis part 53 determines whether or not a behavior performed in a period adjacent to the detected particular behavior agrees with the acquired related behavior.

If a first particular behavior is detected, for example, the behavior analysis part 53 determines whether or not a behavior agreeing with a related behavior associated with the first particular behavior is performed in a period after the first particular behavior. If a behavior agreeing with the related behavior associated with the first particular behavior is performed, the behavior analysis part 53 determines the behavior of the user performed in this period as a related behavior associated with the first particular behavior. Then, the behavior analysis part 53 stores the determined related behavior in association with time and date of this behavior into the analysis result storage part 73.

If a second particular behavior is detected, the behavior analysis part 53 determines whether or not a behavior agreeing with a related behavior associated with the second particular behavior is performed in a period before the second particular behavior. If a behavior agreeing with the related behavior associated with the second particular behavior is performed, the behavior analysis part 53 determines the behavior of the user performed in this period as a related behavior associated with the second particular behavior. Then, the behavior analysis part 53 stores the determined related behavior in association with time and date of this behavior into the analysis result storage part 73.

If the particular behavior detection part 52 detects a combination of a first particular behavior and a second particular behavior, the behavior analysis part 53 determines whether or not a behavior agreeing with a related behavior associated with the first particular behavior and the second particular behavior is performed in a period between the first particular behavior and the second particular behavior. If a behavior agreeing with the related behavior associated with the first particular behavior and the second particular behavior is performed, the behavior analysis part determines the behavior of the user performed in this period as a related behavior associated with the first particular behavior and the second particular behavior. Then, the behavior analysis part 53 stores the determined related behavior in association with time and date of this behavior into the analysis result storage part 73.

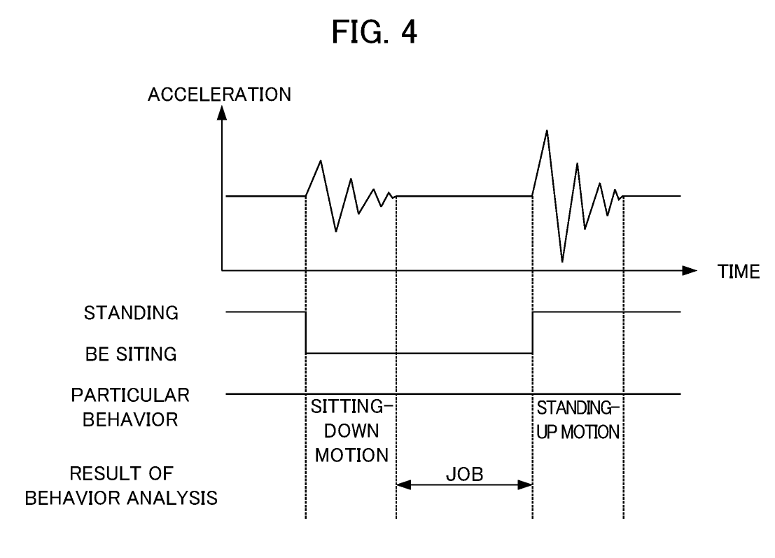

FIG. 4 is a schematic view showing how a related behavior associated with a particular behavior is identified by detecting the particular behavior. The behaviors shown in FIG. 4 are assumed to be performed in a workplace.

As shown in FIG. 4, a standing-up motion and a sitting-down motion can be detected based on outputs from a sensor (here, acceleration sensor). These motions can be determined as a first particular behavior and a second particular behavior respectively.

“Doing a job (desk job)” is associated as a related behavior with a combination of these first particular behavior and second particular behavior. Thus, the behavior analysis part 53 refers to data about a behavior history in a period between the first particular behavior and the second particular behavior stored in the history data storage part 71 to determine whether or not a user's behavior performed in this period agrees with the related behavior of “doing a job (desk job)”. In this embodiment, except in the case where a user's behavior performed in this period apparently disagrees with the related behavior of “doing a job (desk job)”, the behavior analysis part 53 determines the user's behavior performed in this period as the related behavior of “doing a job (desk job)”.

Specifically, it is likely that a behavior of “doing a job (desk job)” will be performed from a sitting-down motion and a standing-up motion made in a workplace. Thus, a result of behavior analysis produced by the behavior analysis part 53 shows that the user's behavior performed in this period is determined as a behavior of “doing a job”. If there is a plurality of related behaviors associated with the same particular behavior (or a combination of particular behaviors), the behavior analysis part 53 refers to the behavior history data about the user to select a related behavior of highest likelihood.

As described above, during behavior analysis by the behavior analysis part 53 of this embodiment, a behavior performed in a period adjacent to a particular behavior is checked against a related behavior associated with the particular behavior stored in the related behavior storage part 72. This only involves a determination about agreement with data about a limited behavior pattern, thereby achieving specific and high-accurate behavior analysis.

In the behavior analysis apparatus 1 of this embodiment, only the sensor information acquisition part 51 and the particular behavior detection part 52 are required to operate continuously or intermittently in the first CPU 11A operable with lower power consumption than the second CPU 11B. Further, the behavior analysis part 53 that operates in the second CPU 11B is only required to be started to coincide with timing of detection of a particular behavior by the particular behavior detection part 52.

Thus, the second CPU 11B is only required to be started as needed for the behavior analysis processing, thereby contributing to reduction in power consumption of the behavior analysis apparatus 1.

### [Operation]

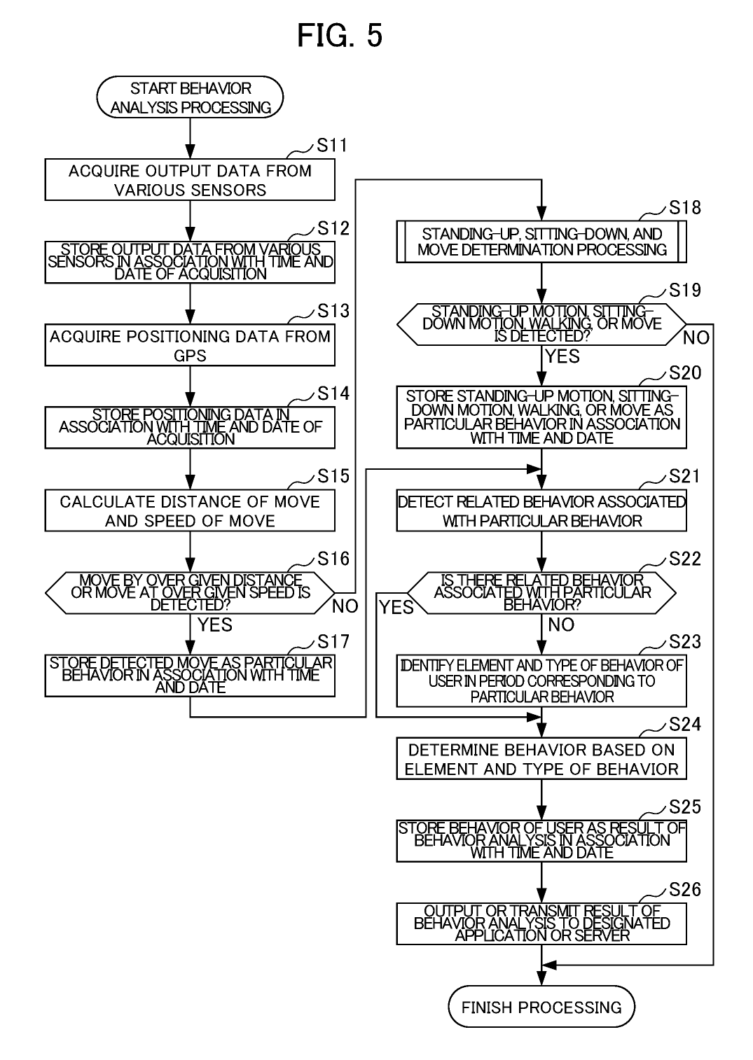

FIG. 5 is a flowchart for explaining a flow of the behavior analysis processing executed by the behavior analysis apparatus 1 of FIG. 1 having the functional configuration of FIG. 2.

The behavior analysis processing starts in response to operation to start the behavior analysis processing performed by a user through the input unit 19.

In step S11, the sensor information acquisition part 51 acquires output data from the various sensors.

In step S12, the sensor information acquisition part 51 stores the output data from the various sensors in association with time and date of the acquisition into the history data storage part 71.

In step S13, the sensor information acquisition part 51 acquires positioning data from the GPS unit 16.

In step S14, the sensor information acquisition part 51 stores the positioning data in association with time and date of the acquisition into the history data storage part 71.

In step S15, the particular behavior detection part 52 refers to behavior history data about the user stored in the history data storage part 71 to calculate a distance of move of the user (a difference between pieces of position information) and a speed of the move (an average speed).

In step S16, the particular behavior detection part 52 determines whether or not a move by over a given distance or a move at over a given speed is detected. A user's move by over the given distance or a user's move at over the given speed is stored as a particular behavior in the related behavior storage part 72.

If a move by over the given distance or a move at over the given speed is detected, a determination of step S16 is YES. Then, the processing flow shifts to step S17.

If a move by over the given distance or a move at over the given speed is not detected, a determination of step S16 is NO. Then, the processing flow shifts to step S18.

In step S17, the particular behavior detection part 52 determines the detected move by over the given distance or move at over the given speed as a particular behavior and stores this particular behavior in association with time and date (stores this particular behavior with a tag) into the history data storage part 71.

In step S18, the particular behavior detection part executes processing of detecting and determining a standing-up motion, a sitting-down motion, and a move (hereinafter called “standing-up, sitting-down, and move determination processing”).

In step S19, the particular behavior detection part 52 determines whether or not a standing-up motion, a sitting-down motion, walking, or a move is detected by the standing-up, sitting-down, and move determination processing.

If a standing-up motion, a sitting-down motion, walking, or a move is detected by the standing-up, sitting-down, and move determination processing, a determination of step S19 is YES. Then, the processing flow shifts to step S20.

If a standing-up motion, a sitting-down motion, walking, or a move is not detected by the standing-up, sitting-down, and move determination processing, a determination of step S19 is NO. Then, the behavior analysis processing is finished.

In step S20, the particular behavior detection part determines the detected standing-up motion, sitting-down motion, walking, or move as a particular behavior and stores this particular behavior in association with time and date (stores this particular behavior with a tag) into the history data storage part 71.

In step S21, the particular behavior detection part detects the particular behavior stored in the related behavior storage part 72 from the behavior history data about the user stored in the history data storage part 71.

In step S22, the behavior analysis part 53 determines whether or not the behavior history data about the user contains a related behavior associated with the detected particular behavior.

If the behavior history data about the user contains a related behavior associated with the detected particular behavior, a determination of step S22 is YES. Then, the processing flow shifts to step S24.

If the behavior history data about the user does not contain a related behavior associated with the detected particular behavior, a determination of step S22 is NO. Then, the processing flow shifts to step S23.

In step S23, the behavior analysis part 53 identifies an element and a type of the behavior performed by the user in a period corresponding to the particular behavior.

In step S24, the behavior analysis part 53 determines a behavior having a likelihood of having been performed by the user based on the element and the type of the behavior.

In step S25, the behavior analysis part 53 determines the behavior of the user performed in the period corresponding to the particular behavior (the related behavior determined to be contained in step S22 or the behavior determined in step S24) as a result of the behavior analysis, and stores the result in association with time and date into the analysis result storage part 73 containing data in chronological order.

In step S26, the behavior analysis part 53 outputs the behavior of the user corresponding to the result of the behavior analysis to a designated application or transmits this behavior to a server. Then, the application or the server provides information or service responsive to a situation of the behavior according to the setting of the behavior analysis apparatus 1.

After step S26, the behavior analysis processing is finished.

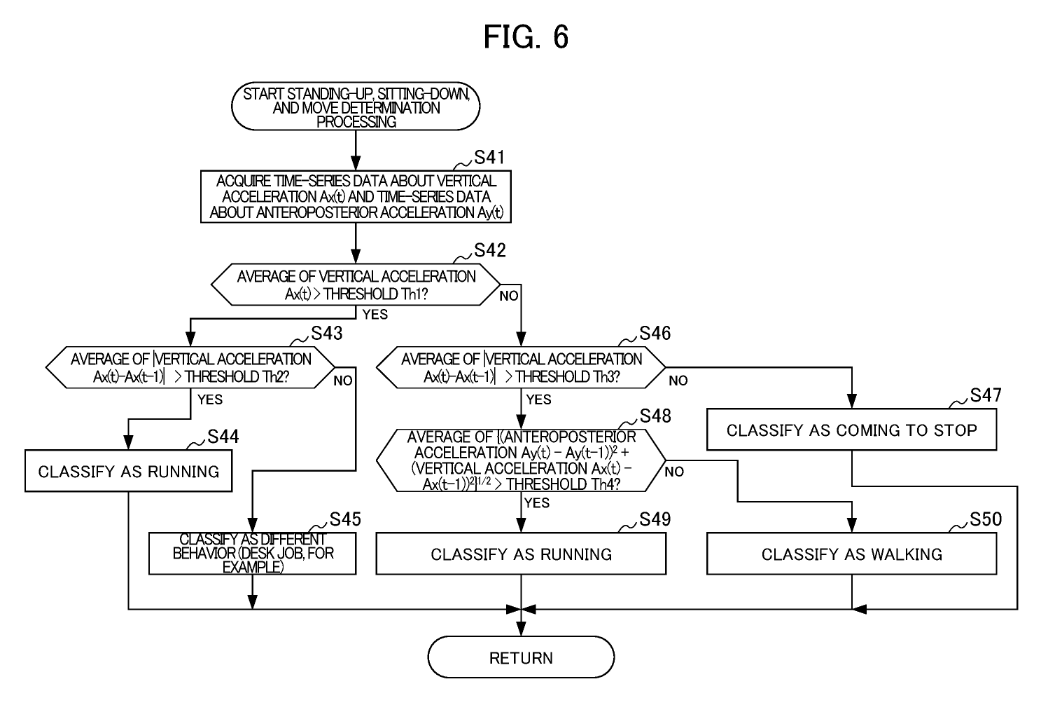

FIG. 6 is a flowchart for explaining a flow of the standing-up, sitting-down, and move determination processing executed in step S18 of the behavior analysis processing. A threshold Th1, a threshold Th2, a threshold Th3, and a threshold Th4 of FIG. 6 are thresholds set in advance for determining a behavior. Specifically, the thresholds Th1 to Th4 can be set by taking advantage of the fact that the magnitude or distribution of an acceleration in the vertical direction differs among human behaviors such as walking, running, and remaining at rest. For example, an acceleration in the vertical direction is generally from 0.5 to 0.6 G during “walking” and from about 0.8 to about 0.9 G during “running”. By contrast, an acceleration in the vertical direction in a resting state is 0.004 G or less in many cases. The thresholds Th1 to Th4 can be set by taking advantage of these various acceleration parameters relating to behavior analysis. These specific numerical values are merely illustrative and variable depending on individual differences, and the like. Thus, these numerical values can be corrected to more suitable numerical values by performing calibration, and the like based on a behavior of a user who uses the behavior analysis apparatus 1.

In step S41, the particular behavior detection part acquires time-series data about a vertical acceleration Ax(t) and time-series data about an anteroposterior acceleration Ay(t).

In step S42, the particular behavior detection part determines whether or not a relationship “average of vertical acceleration Ax(t)>threshold Th1” is established.

If the relationship “average of vertical acceleration Ax(t)>threshold Th1” is established, a determination of step S42 is YES. Then, the processing flow shifts to step S43.

If the relationship “average of vertical acceleration Ax(t)>threshold Th1” is not established, a determination of step S42 is NO. Then, the processing flow shifts to step S46.

In step S43, the particular behavior detection part determines whether or not a relationship “average of |vertical acceleration Ax(t)−Ax(t−1)|>threshold Th2” is established.

If the relationship “average of |vertical acceleration Ax(t)−Ax(t−1)|>threshold Th2” is established, a determination of step S43 is YES. Then, the processing flow shifts to step S44.

If the relationship “average of |vertical acceleration Ax(t)−Ax(t−1)|>threshold Th2” not is established, a determination of step S43 is NO. Then, the processing flow shifts to step S45.

In step S44, the particular behavior detection part 52 classifies the behavior of the user as “running”.

After step S44, the processing flow returns to the behavior analysis processing.

In step S45, the particular behavior detection part classifies the behavior of the user as a “different behavior (desk job, for example)”.

After step S45, the processing flow returns to the behavior analysis processing.

In step S46, the particular behavior detection part determines whether or not a relationship “average of |vertical acceleration Ax(t)−Ax(t−1)|>threshold Th3” is established.

If the relationship “average of |vertical acceleration Ax(t)−Ax(t−1)|>threshold Th3” is established, a determination of step S46 is YES. Then, the processing flow shifts to step S48.

If the relationship “average of |vertical acceleration Ax(t)−Ax(t−1)|>threshold Th3” not established, a determination of step S46 is NO. Then, the processing flow shifts to step S47.

In step S47, the particular behavior detection part 52 classifies the behavior of the user as “coming to a stop”.

After step S47, the processing flow returns to the behavior analysis processing.

In step S48, the particular behavior detection part determines whether or not a relationship “average of {(anteroposterior acceleration Ay(t)−Ay(t−1))²+|vertical acceleration Ax(t)−Ax(t−1))²}^{1/2}>threshold Th4” is established.

If the relationship “average of {(anteroposterior acceleration Ay(t)−Ay(t−1))²+|vertical acceleration Ax(t)−Ax(t−1))²}^{1/2}>threshold Th4” is established, a determination of step S48 is YES. Then, the processing flow shifts to step S49.

If the relationship “average of {(anteroposterior acceleration Ay(t)−Ay(t−1))²+|vertical acceleration Ax(t)−Ax(t−1))²}^{1/2}>threshold Th4” is not established, a determination of step S48 is NO. Then, the processing flow shifts to step S50.

In step S49, the particular behavior detection part 52 classifies the behavior of the user as “running”.

After step S49, the processing flow returns to the behavior analysis processing.

In step S50, the particular behavior detection part 52 classifies the behavior of the user as “walking”.

After step S50, the processing flow returns to the behavior analysis processing.

As a result of the above-described processing, a particular behavior is detected in behavior history data about a user and a related behavior associated with the detected particular behavior is acquired as a result of behavior analysis.

In this way, a behavior of the user having a high probability, which is a behavior performed before or after the particular behavior, is acquired more easily as a result of the behavior analysis.

As a result, a behavior of the user can be analyzed more properly.

### Second Embodiment

A second embodiment of the present invention will be described next.

In the first embodiment, behavior history data about a user stored in the history data storage part 71 is a target of the behavior analysis processing.

By contrast, behavior history data about a user input in real time (output data from a sensor, for example) can be a target of the behavior analysis processing.

In this case, the particular behavior detection part 52 monitors behavior history data about a user acquired sequentially by the sensor information acquisition part 51. If a first particular behavior is detected, the behavior analysis part 53 determines whether or not behavior history data about the user acquired thereafter agrees with a related behavior stored in the related behavior storage part 72 in association with this first particular behavior.

If the behavior history data acquired thereafter is determined to agree with this related behavior, this related behavior is determined as a behavior performed after the first particular behavior.

Regarding a second particular behavior, behavior history data about the user acquired sequentially for a given period of time by the sensor information acquisition part 51 is buffered. The particular behavior detection part 52 monitors the behavior history data about the user acquired sequentially by the sensor information acquisition part 51. If a second particular behavior is detected, it is determined whether or not the buffered behavior history data about the user agrees with a related behavior stored in the related behavior storage part 72 in association with this second particular behavior.

If the buffered behavior history data is determined to agree with this related behavior, this related behavior is determined as a behavior performed before the second particular behavior.

If a combination of a first particular behavior and a second particular behavior is defined as a particular behavior, the particular behavior detection part 52 monitors behavior history data about the user acquired sequentially by the sensor information acquisition part 51. If the first particular behavior is detected, the behavior history data about the user acquired before detection of the second particular behavior is buffered. If the second particular behavior is detected, the behavior analysis part 53 determines whether or not the buffered behavior history data about the user agrees with a related behavior stored in the related behavior storage part 72 in association with these first particular behavior and second particular behavior.

If the buffered behavior history data is determined to agree with this related behavior, this related behavior is determined as a behavior performed between the first particular behavior and the second particular behavior.

In this way, behavior history data about the user input in real time (output data from a sensor, for example) can also be a target of the behavior analysis processing.

As a result, a behavior of the user can be analyzed more properly. First Modification]

In the above-described embodiments, the behavior analysis processing is to detect a standing-up motion, a sitting-down motion, walking, or a move as a particular behavior. Meanwhile, a behavior to be set as a particular behavior can also be a move by means of transportation, for example.

Specifically, statistically analyzing output data from the acceleration sensor, the air pressure sensor, and the magnetic sensor achieves detection of the following moves in such a manner that the following moves are distinguished from each other: walking, running, going up and down stairs, going up and down by an elevator, a move by train, a move by bus, a move by a passenger car, etc. Thus, these moves can be set as particular behaviors.

Processing described below is executed for detecting a move by train, a move by bus, a move by a passenger car, walking, and running as particular behaviors (this processing will hereinafter be called “moving means determination processing”).

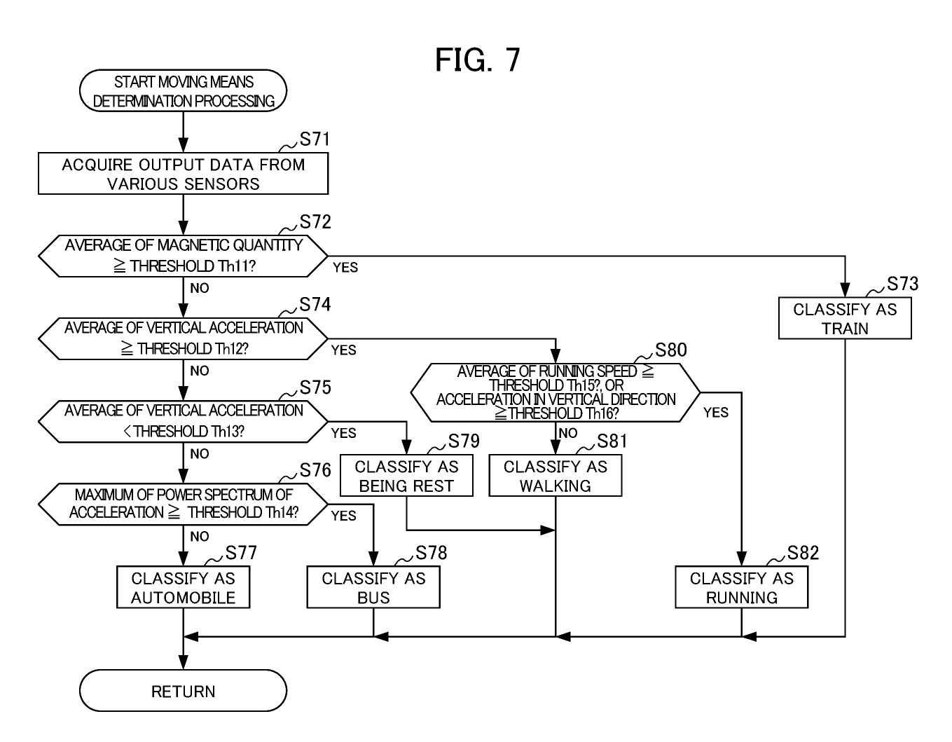

FIG. 7 is a flowchart for explaining a flow of the moving means determination processing.

The moving means determination processing can be executed in step S18 of the behavior analysis processing instead of or together with the standing-up, sitting-down, and move determination processing. A threshold Th11, a threshold Th12, a threshold Th13, a threshold Th14, a threshold Th15, and a threshold Th16 of FIG. 7 are thresholds set in advance for determining moving means. As a specific example, a triaxial combined acceleration widely distributes in a range from 1 to 1.2 G in the case of “running”, whereas it distributes in a range around 1.03 to 1.05 G in the case of “walking”. In many cases, a triaxial combined acceleration concentrates in a narrow range from about 0.98 to about 1.01 G in the case of each of “automobile,” “bus”, and “train”. Thus, “walking”, “running”, and the like can be distinguished from “automobile”, “bus”, and the like. Further, a triaxial combined magnetic quantity observed in a normal state in Tokyo and its vicinity is about 45 [μT] and is substantially constant in a range from 40 to 50 [μT] in the case of “walking” and 30 [μT] in the case of “automobile” and “bus”. Meanwhile, magnetism of 100 [μT] or more, which is not generated normally, is observed frequently in the case of “train”. Thus, “train” and the other moves can generally be distinguished easily from each other. A power spectrum of an acceleration in the lateral direction or a traveling direction or an acceleration in the vertical direction differs between “automobile” and “bus”. Thus, “automobile” and “bus” can be distinguished from each other by analyzing such a power spectrum or such an acceleration. Additionally, a person may determine whether being on a bus route or on a different road using position information about the person himself or herself. This determination can also be used for distinguishing “automobile” and “bus” from each other. The thresholds Th11 to Th16 may be set in consideration of information about the parameters given above.

In step S71, the sensor information acquisition part 51 acquires output data from the various sensors.

In step S72, the particular behavior detection part determines whether or not a relationship “average of magnetic quantity ≧threshold Th11” is established.

If the relationship “average of magnetic quantity ≧threshold Th11” is established, a determination of step S72 is YES. Then, the processing flow shifts to step S73.

If the relationship “average of magnetic quantity ≧threshold Th11” is not established, a determination of step S72 is NO. Then, the processing flow shifts to step S74.

In step S73, the particular behavior detection part 52 classifies moving means of a user as “train”.

In step S74, the particular behavior detection part determines whether or not a relationship “average of vertical acceleration ≧threshold Th12” is established.

If the relationship “average of vertical acceleration ≧threshold Th12” is established, a determination of step S74 is YES. Then, the processing flow shifts to step S80.

If the relationship “average of vertical acceleration ≧threshold Th12” is not established, a determination of step S74 is NO. Then, the processing flow shifts to step S75.

In step S75, the particular behavior detection part determines whether or not a relationship “average of vertical acceleration <threshold Th13” is established.

If the relationship “average of vertical acceleration <threshold Th13” is established, a determination of step S75 is YES. Then, the processing flow shifts to step S79.

If the relationship “average of vertical acceleration <threshold Th13” is not established, a determination of step S75 is NO. Then, the processing flow shifts to step S76.

In step S76, the particular behavior detection part 52 determines whether or not a relationship “maximum of power spectrum of acceleration ≧threshold Th14” is established.

If the relationship “maximum of power spectrum of acceleration ≧threshold Th14” is established, a determination of step S76 is YES. Then, the processing flow shifts to step S78.

If the relationship “maximum of power spectrum of acceleration ≧threshold Th14” is not established, a determination of step S76 is NO. Then, the processing flow shifts to step S77.

In step S77, the particular behavior detection part classifies moving means of the user as “automobile (passenger car)”.

In step S78, the particular behavior detection part 52 classifies moving means of the user as “bus”.

In step S79, the particular behavior detection part 52 classifies moving means of the user as “being at rest”.

In step S80, the particular behavior detection part determines whether or not a relationship “average of running speed ≧threshold Th15” or a relationship “acceleration in the vertical direction ≧threshold Th16” is established.

If the relationship “average of running speed threshold Th15” or the relationship “acceleration in the vertical direction ≧threshold Th16” is established a determination of step S80 is YES. Then, the processing flow shifts to step S82.

If the relationship “average of running speed threshold Th15” and the relationship “acceleration in the vertical direction ≧threshold Th16” are not established, a determination of step S80 is NO. Then, the processing flow shifts to step S81.

In step S81, the particular behavior detection part 52 classifies moving means of the user as “walking”.

In step S82, the particular behavior detection part 52 classifies moving means of the user as “running”.

As a result of the above-described processing, moving means of the user can be set as a particular behavior. Thus, by setting a variety of behaviors as particular behaviors, a behavior of the user can be analyzed more properly.

The behavior analysis apparatus 1 having the above-described configuration includes the particular behavior detection part 52 and the behavior analysis part 53.

The particular behavior detection part 52 detects a particular behavior of a user.

The behavior analysis part 53 analyzes a related behavior of the user performed in a period corresponding to the particular behavior.

Thereby, a behavior of the user having a high probability, which is a behavior performed in the period corresponding to the particular behavior, is acquired more easily as a result of behavior analysis.

As a result, a behavior of the user can be analyzed more properly.

Further, a behavior performed before or after the particular behavior is expected based on this particular behavior (by using this particular behavior). This facilitates execution of the processing, compared to analyzing a behavior without referring to anything. As a result, a behavior can be analyzed without the need of utilizing great deal of CPU power.

The particular behavior detection part 52 detects the particular behavior as a cue for behavior analysis.

The behavior analysis part 53 analyzes the related behavior of the user performed in a period adjacent to the particular behavior.

Thereby, a behavior of the user having a high probability, which is a behavior performed before or after the particular behavior, is acquired more easily as a result of the behavior analysis by using the particular behavior as a cue.

As a result, a behavior of the user can be analyzed more properly.

The behavior analysis part 53 analyzes the related behavior of the user, which is a behavior performed in the period corresponding to the particular behavior, in association with the particular behavior.

This allows analysis of the related behavior associated with the particular behavior, so that a behavior of the user can be analyzed more specifically with higher accuracy.

The particular behavior detection part 52 detects a first particular behavior corresponding to start of a behavior.

The behavior analysis part 53 analyzes a behavior of the user, which is a behavior performed in a period after detection of the first particular behavior, in association with the first particular behavior.

Thereby, the behavior performed after the first particular behavior can be analyzed more specifically with higher accuracy.

The particular behavior detection part 52 detects a second particular behavior corresponding to end of a behavior.

The behavior analysis part 53 analyzes a behavior of the user, which is a behavior performed in a period before detection of the second particular behavior, in association with the second particular behavior.

Thereby, the behavior performed before the second particular behavior can be analyzed more specifically with higher accuracy.

The particular behavior detection part 52 detects a first particular behavior corresponding to start of a behavior and a second particular behavior corresponding to end of the behavior.

The behavior analysis part 53 analyzes a behavior of the user, which is a behavior performed between time of detection of the first particular behavior and time of detection of the second particular behavior, in association with the first particular behavior and the second particular behavior.

Thereby, the behavior performed between the first particular behavior and the second particular behavior can be analyzed more specifically with higher accuracy.

The particular behavior detection part 52 detects at least one of i) a combination of a plurality of behaviors of the user or ii) a single behavior of the user as the particular behavior.

Thereby, a more suitable particular behavior can be defined, so that a behavior of the user can be analyzed more properly.

The behavior analysis apparatus 1 further includes the related behavior storage part 72.

The related behavior storage part 72 contains the particular behavior and a behavior of the user highly related to this particular behavior that are stored in association with each other in advance.

If the particular behavior detection part 52 detects the particular behavior, the behavior analysis part 53 refers to the behavior of the user highly related to the particular behavior stored in the related behavior storage part 72 to analyze a behavior of the user.

Thereby, the behavior highly related to the particular behavior can be defined in advance, and a behavior of the user can be analyzed more easily by referring to the defined behavior.

The particular behavior detection part 52 is configured by the first CPU 11A provided in the behavior analysis apparatus 1.

The behavior analysis part 53 is configured by the second CPU 11B provided in the behavior analysis apparatus 1.

The first CPU 11A operates with lower power consumption than the second CPU 11B.

This can contribute to reduction in power consumption of the behavior analysis apparatus 1.

The behavior analysis apparatus 1 includes the history data storage part 71.

The history data storage part 71 contains a history of data acquired in relation to a behavior of the user.

The particular behavior detection part 52 detects the particular behavior based on the data stored in the history data storage part 71.

The behavior analysis part 53 uses the detected particular behavior as a basis to analyze a behavior indicated by the data stored in the history data storage part 71.

Thereby, the history data acquired in the past by the behavior analysis apparatus 1 can be a target of detection of a particular behavior and behavior analysis.

The behavior analysis part 53 analyzes a behavior of the user performed in the period adjacent to the particular behavior, and determines the analyzed behavior as one behavior result.

Thereby, a substance of a behavior, which is a behavior indicated by an entire behavior of the user performed in the period adjacent to the particular behavior, can be acquired as a behavior result.

It should be noted that the present invention is not to be limited to the aforementioned embodiments, and that modifications, improvements, etc. within a scope that can achieve the objects of the present invention are also included in the present invention.

For example, in the above-described embodiments, a particular behavior and a related behavior are associated with each other in advance. However, this is not to limit the present invention. A related behavior associated with a particular behavior may be extracted sequentially from a behavior history of a user or an operation history of the behavior analysis apparatus 1, for example.

In the above-described embodiments, positioning data or output data from the various sensors may be acquired from a different apparatus working in conjunction with the behavior analysis apparatus 1.

In the above-described embodiments, a particular behavior is used as a cue (trigger) for analysis of a behavior of a user and a behavior of the user is analyzed in a period adjacent to this particular behavior. Alternatively, a behavior of the user may be analyzed in a period when the particular behavior is detected.

In step 23 of the behavior analysis processing according to above-described embodiments, the behavior analysis part 53 identifies an element and a type of a behavior performed by a user in a period corresponding to a particular behavior. In this step, a behavior of the user can be identified based on various types of information grasped by the behavior analysis apparatus 1. For example, a type or intensity of a job or sport, etc. can be identified by analyzing biometric information, motion information, or environmental information. Further, a region such as a place of departure or a destination, a location, an intended matter, a purpose, etc. can be determined by analyzing positioning data, regional information, a locus of a move, a distance of the move, staying time, or a schedule, for example. Additionally, a communication counterpart, the face of a particular person, face recognition, scene recognition, an intended matter in a message, a file type, etc. can be determined or achieved by analyzing a history of use of an electronic mail, social networking service (SNS), an captured image, an application, or a file, for example. Additionally, an ID, a type, or an installation place of an appliance or a tag belonging to a communication counterpart, or a registered belonging of the communication counterpart can be determined by analyzing a communication history of a radio station, a WiFi station, a Bluetooth (BT, registered trademark) appliance, or a detected RFID tag or NFC tag used for communication, for example.

In the above-described embodiments, to store a particular behavior or a behavior history clearly, a device for reading an RFID tag or an NFC tag may be installed on a certain place such as a workplace (a desk of a user himself or herself, for example), a house, or an automobile. Then, as necessary, the user may make the device read the RFID tag, etc. Likewise, a behavior history to be stored may indicate reading for example of the RFID tag at a ticket gate in a station, etc.

In the above-described embodiments, the behavior analysis apparatus 1 to which the present invention is applied is a smartphone or a wearable appliance such as a wrist terminal, for example. However, this is not to particularly limit the present invention.

For example, the present invention is applicable to general electronic appliances having the function to execute the behavior analysis processing. As specific examples, the present invention is applicable to a notebook-type personal computer, a television receiver, a video camera, a portable navigation system, a portable phone, and a portable game machine, etc. The present invention is further applicable to a glasses-type wearable appliance as a wearable appliance other than a wrist terminal, for example. This achieves detection of the motion of the mouth of a user, so that a behavior of the user of having a meal or making conversation can be determined more correctly.

The processing sequence described above can be executed by hardware, and can also be executed by software.

In other words, the hardware configuration of FIG. 2 is merely an illustrative example, and the present invention is not particularly limited thereto. More specifically, the types of functional blocks employed to realize the above-described functions are not particularly limited to the examples shown in FIG. 2, so long as the information processing apparatus 1 can be provided with the functions enabling the aforementioned processing sequence to be executed in its entirety.

A single functional block may be configured by a single piece of hardware, a single installation of software, or a combination thereof.

The functional configurations of the present embodiment are realized by a processor executing arithmetic processing, and processors that can be used for the present embodiment include a unit configured by a single unit of a variety of single processing devices such as a single processor, multi-processor, multi-core processor, etc., and a unit in which the variety of processing devices are combined with a processing circuit such as ASIC (Application Specific Integrated Circuit) or FPGA (Field-Programmable Gate Array).

In the case of having the series of processing executed by software, the program constituting this software is installed from a network or recording medium to a computer or the like.

The computer may be a computer equipped with dedicated hardware.

In addition, the computer may be a computer capable of executing various functions, e.g., a general purpose personal computer, by installing various programs.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, the ROM 12 of FIG. 1 in which the program is recorded or a hard disk, etc. included in the storage unit 21 of FIG. 1.

It should be noted that, in the present specification, the steps defining the program recorded in the storage medium include not only the processing executed in a time series following this order, but also processing executed in parallel or individually, which is not necessarily executed in a time series.

In addition, in the present specification, the term ‘system’ shall mean a general device configured with a plurality of devices, a plurality of means, and the like.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. A behavior analysis apparatus comprising a processor(s), wherein the processor(s) executes:
a particular behavior acquisition processing of identifying a particular behavior of a user; and
a behavior analysis processing of analyzing a related behavior of the user in a period corresponding to the particular behavior.

2. The behavior analysis apparatus according to claim 1, wherein the particular behavior acquisition processing comprises identifying the particular behavior as a cue for behavior analysis, and
the behavior analysis processing comprises analyzing the related behavior of the user performed in a period adjacent to the particular behavior.

3. The behavior analysis apparatus according to claim 1, wherein the behavior analysis processing comprises analyzing the related behavior of the user, which is a behavior performed in the period corresponding to the particular behavior, in association with the particular behavior.

4. The behavior analysis apparatus according to claim 3, wherein the particular behavior acquisition processing comprises identifying a first particular behavior corresponding to start of a behavior, and
the behavior analysis processing comprises analyzing a behavior of the user, which is a behavior performed in a period after identification of the first particular behavior, in association with the first particular behavior.

5. The behavior analysis apparatus according to claim 3, wherein the particular behavior acquisition processing comprises identifying a second particular behavior corresponding to end of a behavior, and
the behavior analysis processing comprises analyzing a behavior of the user, which is a behavior performed in a period before identification of the second particular behavior, in association with the second particular behavior.

6. The behavior analysis apparatus according to claim 3, wherein the particular behavior acquisition processing comprises identifying a first particular behavior corresponding to start of a behavior and a second particular behavior corresponding to end of the behavior, and
the behavior analysis processing comprises analyzing a behavior of the user, which is a behavior performed between time of identification of the first particular behavior and time of identification of the second particular behavior, in association with the first particular behavior and/or the second particular behavior.

7. The behavior analysis apparatus according to claim 1, wherein the particular behavior acquisition processing comprises identifying at least one of i) a combination of a plurality of behaviors of the user or ii) a single behavior of the user as the particular behavior.

8. The behavior analysis apparatus according to claim 1, further comprising related behavior storage area of containing the particular behavior and a behavior of the user highly related to the particular behavior that are stored in association with each other in advance, wherein
if the particular behavior acquisition processing identifies the particular behavior, the behavior analysis processing refers to the behavior of the user highly related to the particular behavior stored in the related behavior storage area to analyze a behavior of the user.

9. The behavior analysis apparatus according to claim 1, further comprising a first processor and a second processor as the processors, wherein the particular behavior acquisition processing is executed by the first processor,
wherein the behavior analysis processing is executed by the second processor, and
wherein the first processor operates with lower power consumption than the second processor.

10. The behavior analysis apparatus according to claim 1, comprising history data storage area containing a history of data acquired in relation to a behavior of the user, wherein
the particular behavior acquisition processing comprises acquiring the particular behavior based on the data stored in the history data storage area, and
the behavior analysis processing comprises using the identified particular behavior as a basis to analyze a behavior indicated by the data stored in the history data storage area

11. The behavior analysis apparatus according to claim 1, wherein the behavior analysis processing comprises analyzing a behavior of the user performed in a period adjacent to the particular behavior, and determining the analyzed behavior as one behavior result.

12. A behavior analysis method executed by a behavior analysis apparatus, the method comprising:
a particular behavior acquisition processing of identifying a particular behavior of a user; and
a behavior analysis processing of analyzing a related behavior of the user in a period corresponding to the particular behavior.

13. The behavior analysis method according to claim 12, wherein the particular behavior acquisition processing comprises identifying the particular behavior as a cue for behavior analysis, and
the behavior analysis processing comprises analyzing the related behavior of the user performed in a period adjacent to the particular behavior.

14. The behavior analysis method according to claim 12, wherein the behavior analysis processing comprises analyzing the related behavior of the user in association with the particular behavior.

15. The behavior analysis method according to claim 14, wherein the particular behavior acquisition processing comprises identifying a first particular behavior corresponding to start of a behavior, and
the behavior analysis processing comprises analyzing a behavior of the user, which is a behavior performed in a period after identification of the first particular behavior, in association with the first particular behavior.

16. The behavior analysis method according to claim 14, wherein the particular behavior acquisition processing comprises identifying a second particular behavior corresponding to end of a behavior, and
the behavior analysis processing comprises analyzing a behavior of the user, which is a behavior performed in a period before identification of the second particular behavior, in association with the second particular behavior.

17. The behavior analysis method according to claim 14, wherein the particular behavior acquisition processing comprises identifying a first particular behavior corresponding to start of a behavior and a second particular behavior corresponding to end of the behavior, and
the behavior analysis processing comprises analyzing a behavior of the user, which is a behavior performed between time of identification of the first particular behavior and time of identification of the second particular behavior, in association with the first particular behavior and/or the second particular behavior.

18. The behavior analysis method according to claim 12, wherein the particular behavior acquisition processing comprises identifying at least one of i) a combination of a plurality of behaviors of the user or ii) a single behavior of the user as the particular behavior.

19. The behavior analysis method according to claim 12, further comprising a related behavior storage processing of storing the particular behavior and a behavior of the user highly related to the particular behavior in association with each other in advance, wherein
if the particular behavior is identified by the particular behavior acquisition processing, the behavior analysis processing comprises referring to the behavior of the user highly related to the particular behavior stored by the related behavior storage processing to analyze a behavior of the user.

20. A non-transitory storage medium encoded with a computer-readable program that controls a processor(s) of a behavior analysis apparatus to execute:
a particular behavior acquisition processing of identifying a particular behavior of a user; and
a behavior analysis processing of analyzing a related behavior of the user in a period corresponding to the particular behavior.
